(19) United States
(12) Patent Application Publication
(10) Pub. No.: US 2013/0225219 A1
(43) Pub. Date: Aug. 29, 2013

(54) BASE STATION, CORE SERVER AND UPLINK TRANSMISSION METHOD FOR USING IN A WIRELESS NETWORK COMMUNICATION SYSTEM

(71) Applicants: Heng-Iang HSU, Taipei City (TW); Shiann-Tsong SHEU, Taipei City (TW); Chun-Hsiang CHIU, Keelung City (TW); Hsien-Hao LAI, Kaohsiung City (TW); Shu-Hua KAO, New Taipei City (TW)

(72) Inventors: Heng-Iang HSU, Taipei City (TW); Shiann-Tsong SHEU, Taipei City (TW); Chun-Hsiang CHIU, Keelung City (TW); Hsien-Hao LAI, Kaohsiung City (TW); Shu-Hua KAO, New Taipei City (TW)

(73) Assignee: INSTITUTE FOR INFORMATION INDUSTRY, Taipei (TW)

(21) Appl. No.: 13/443,134

(22) Filed: Apr. 10, 2012

(30) Foreign Application Priority Data
Feb. 23, 2012 (TW) 101105921

(51) Int. Cl. H04W 72/04

(52) U.S. Cl. 455/509

(57) ABSTRACT

A base station, a core server and an uplink transmission method thereof for using in a wireless network communication system are provided. The core server creates a time assignment instruction according to a first uplink transmission status of a first machine to machine wireless apparatus group. The core server further transmits the time assignment instruction to the base station. The base station transmits a time assignment signal to the machine to machine wireless apparatus group according to the time assignment instruction so that the machine to machine wireless apparatus group transmits at least one first uplink transmission request to the base station in a time interval according to the time assignment signal.

### PRIORITY

This application claims priority to Taiwan Patent Application No. 101105921, filed on Feb. 23, 2012, which is hereby incorporated by reference in its entirety.

### FIELD

The present invention provides a base station, a core server and an uplink transmission method for using in a wireless network communication system; and more particularly, the present invention provides a base station, a core server and an uplink transmission method for dynamically scheduling uplink transmissions in machine to machine (M2M) wireless apparatuses.

### BACKGROUND

With the advancement of science and technologies, various wireless network technologies have been developed in succession to satisfy the diversified needs for wireless networks. However, as wireless network technologies are developed in succession, there is a compromise between new and old wireless network technologies. For this reason, improving wireless network technologies without disrupting original wireless network technologies is expected.

Over recent years, machine to machine (M2M) wireless networks have emerged gradually under the framework of the Long Term Evolution (LTE) system of the 3rd Generation Partnership Project (3GPP). An M2M wireless network allows different apparatuses to communicate with and exchange data with each other without the need of human to machine (HM) interactions or with the need of only few HM interactions. Because of modern people's needs for M2M wireless networks and the conveniences brought about by M2M wireless networks, almost all wireless network service providers are now contending to introduce the concept of M2M to gain great benefits from this innovative service concept.

Although the concept of M2M has been gradually merged into existing wireless networks, there are still many problems to overcome to effectively deploy M2M wireless communication apparatuses without affecting the operations of existing wireless networks. For example, under the framework of the LTE system of the 3GPP, human to human (H2H) wireless communication apparatuses, together with a lot of M2M wireless communication apparatuses, will choose one of sixty four preambles to transmit uplink transmission requests to an evolved node base station (eNodeB).

The sixty four preambles are shared by all of the H2H wireless communication apparatuses and the M2M wireless communication apparatuses. Therefore, once a plurality of wireless communication apparatuses, which have chosen the same preamble, transmit requests to a base station to contend for the uplink transmission bandwidth within the same time interval, preamble collisions will occur when the wireless communication apparatuses with the same preamble transmit uplink transmission requests. As a result, wireless communication apparatuses experiencing transmission collisions must wait for a period of time before they can transmit uplink transmission requests to the base station again. Consequently, as the numbers of M2M wireless apparatuses become increasingly larger, the wireless communication apparatuses will experience a lot of preamble collisions and the overall performance of the wireless network system will be degraded.

Accordingly, it is important to effectively reduce the possibilities of preamble collisions among M2M wireless apparatuses and H2H wireless apparatuses during uplink data transmissions without disrupting the existing wireless network frameworks.

### SUMMARY

An objective of the present invention is to provide a base station, a core server and an uplink transmission method for using in a wireless network communication system. In detail, by assigning M2M wireless apparatuses that belong to the same group to transmit uplink transmission requests within a specific time interval, the base station, the core server and the uplink transmission method for using in a wireless network communication system according to the present invention are improved; that is, the time interval in which the M2M wireless apparatuses transmit uplink transmission requests overlaps with the time intervals in which the H2H wireless apparatuses and M2M wireless apparatuses of other M2M wireless apparatus groups transmit uplink transmission requests is avoided. Furthermore, the existing wireless network frameworks are not disrupted. Thereby, the possibilities of preamble collisions among M2M wireless apparatuses and H2H wireless apparatuses during uplink data transmissions can be reduced.

To achieve the aforesaid objective, certain embodiments of the present invention provide a base station for using in a wireless network communication system. The wireless network communication system comprises a first machine to machine (M2M) wireless apparatus group, a core server and the base station. The core server is configured to create a time assignment instruction according to a first uplink transmission status of the first M2M wireless apparatus group.

The base station comprises a transceiver and a timing controller electrically connected to the transceiver. The transceiver is configured to receive the time assignment instruction from the core server. The timing controller is configured to control the transceiver to transmit a first time assignment signal to the first M2M wireless apparatus group according to the time assignment instruction so that at least one M2M wireless apparatus of the first M2M wireless apparatus group transmits at least one first uplink transmission request to the transceiver in a first time interval according to the first time assignment signal.

To achieve the aforesaid objective, certain embodiments of the present invention further provide a core server for using in a wireless network communication system. The wireless network communication system comprises a first M2M wireless apparatus group, a base station and the core server. The core server comprises a transceiver and a timing generator electrically connected to the transceiver.

The timing generator is configured to create a time assignment instruction according to a first uplink transmission status of the first M2M wireless apparatus group. The timing generator is further configured to control the transceiver to transmit the time assignment instruction to the base station so that the base station transmits a first time assignment signal to the first M2M wireless apparatus group according to the time assignment instruction. At least one M2M wireless apparatus of the first M2M wireless apparatus group transmits at least one first uplink transmission request to the base station in a first time interval according to the first time assignment signal.

To achieve the aforesaid objective, certain embodiments of the present invention further provide an uplink transmission method for using in a wireless network communication system. The wireless network communication system comprises a first M2M wireless apparatus group, a core server and a base station. The uplink transmission method comprises the following steps:

(a) creating a time assignment instruction by the core server according to a first uplink transmission status of the first M2M wireless apparatus group;

(b) transmitting the time assignment instruction to the base station by the core server; and

(c) transmitting a first time assignment signal to the first M2M wireless apparatus group by the base station according to the time assignment instruction so that at least one M2M wireless apparatus of the first M2M wireless apparatus group transmits at least one first uplink transmission request to the base station in a first time interval according to the first time assignment signal.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic connection diagram of a wireless network communication system 1 according to a first embodiment of the present invention;

FIG. 2 is a flowchart diagram illustrating the operations of the wireless network communication system 1 according to the first embodiment of the present invention;

FIG. 3 is a schematic timing diagram of the wireless network communication system 1 according to the first embodiment of the present invention;

FIG. 4 is a schematic connection diagram of a wireless network communication system 3 according to a second embodiment of the present invention;

FIG. 5 is a flowchart diagram illustrating the operations of the wireless network communication system 3 according to the second embodiment of the present invention;

FIG. 6 is a schematic timing diagram of the wireless network communication system 3 according to the second embodiment of the present invention;

FIG. 7 is a flowchart diagram of an uplink transmission method according to a third embodiment of the present invention; and

FIG. 8 is a flowchart diagram of an uplink transmission method according to a fourth embodiment of the present invention.

### DETAILED DESCRIPTION

In the following descriptions, the present invention will be explained with reference to example embodiments thereof. It shall be appreciated that these example embodiments are not intended to limit the present invention to any specific environments, examples, embodiments, applications or particular implementations described in these example embodiments and the attached drawings. Therefore, the description of these example embodiments and the attached drawings is only for the purpose of illustration rather than to limit the present invention. The scope claimed in this application shall be governed by the claims. Additionally, in the following example embodiments and attached drawings, elements not directly related to the present invention are omitted from depiction. Dimensional relationships among individual elements in the attached drawings are illustrated only for the ease of understanding but not to limit the actual scale.

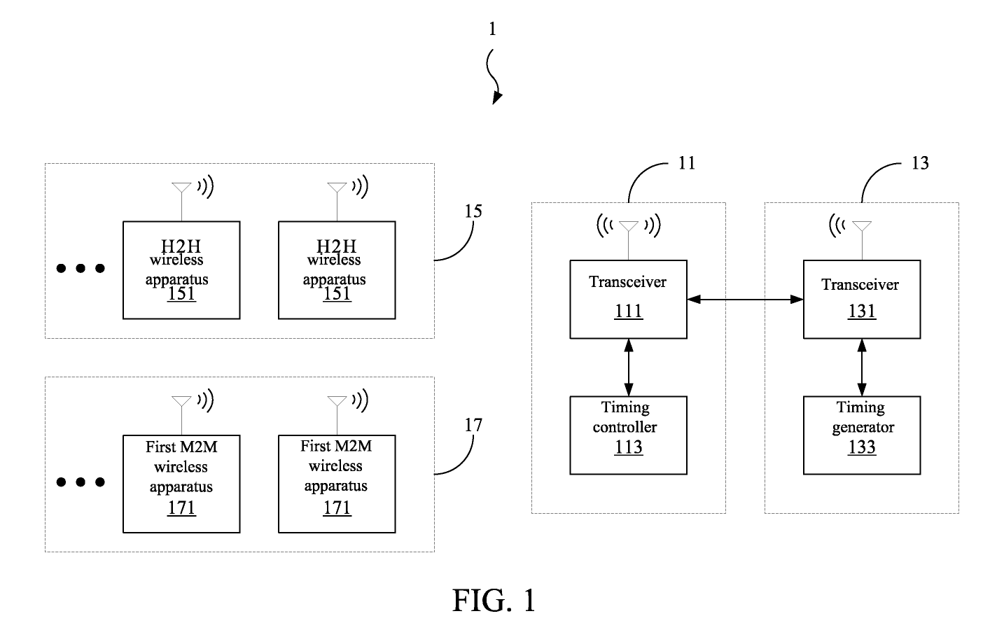

In reference to FIGS. 1, 2 and 3, a first embodiment of the present invention is a wireless network communication system 1. For convenience of description, the wireless network communication system 1 of this embodiment conforms to the Long Term Evolution (LTE) standard of the 3rd Generation Partnership Project (3GPP); however, in other embodiments, the wireless network communication system 1 may also conform to other wireless network communication standards such as the Worldwide Interoperability for Microwave Access (WiMAX) standard.

FIG. 1 is a schematic connection diagram of the wireless network communication system 1 according to the first embodiment of the present invention. As shown in FIG. 1, the wireless network communication system 1 comprises a base station 11, a core server 13, a human to human (H2H) wireless apparatus group 15 and a first machine to machine (M2M) wireless apparatus group 17. Based on the LTE standard of the 3GPP, the core server 13 may comprise a mobility management entity (MME), a serving gateway (S-GW) and a packet data network gateway (P-GW).

The base station 11 comprises a transceiver 111 and a timing controller 113 electrically connected to the transceiver 111. The core server 13 comprises a transceiver 131 and a timing generator 133 electrically connected to the transceiver 131. The transceiver 111 of the base station 11 and the transceiver 131 of the core server 13 can substantially communicate with and exchange data with each other in a wired or wireless way. It shall be appreciated that in other embodiments, the base station 11 and the core server 13 may also be viewed as a single unit, and this will not affect the normal operations of the wireless network communication system 1 of this embodiment.

The first M2M wireless apparatus group 17 comprises a plurality of first M2M wireless apparatuses 171, which can communicate with and exchange data with the transceiver 111 of the base station 11 in a wireless way. Those of ordinary skill in the art can readily appreciate that even having only one first M2M wireless apparatus 171 in the first M2M wireless apparatus group 17 will not affect the normal operations of the wireless network communication system 1 of the present invention, and this essentially still falls within the scope of this application. In other words, the number of first M2M wireless apparatus(es) 171 comprised in the first M2M wireless apparatus group 17 is not limited to what is depicted in FIG. 1.

The H2H wireless apparatus group 15 comprises a plurality of H2H wireless apparatuses 151, which will transmit a plurality of H2H uplink transmission requests R0 to the transceiver 111 of the base station 11 within an H2H time interval T0. The H2H wireless apparatus group 15 and the H2H wireless apparatuses 151 comprised therein are only intended to illustrate the operation process of the wireless network communication system 1 of this embodiment. Therefore, whether or not the wireless network communication system 1 comprises the H2H wireless apparatus group 15 and the H2H wireless apparatuses 151 comprised therein will not substantially affect the normal operations of the wireless network communication system 1 of the present invention.

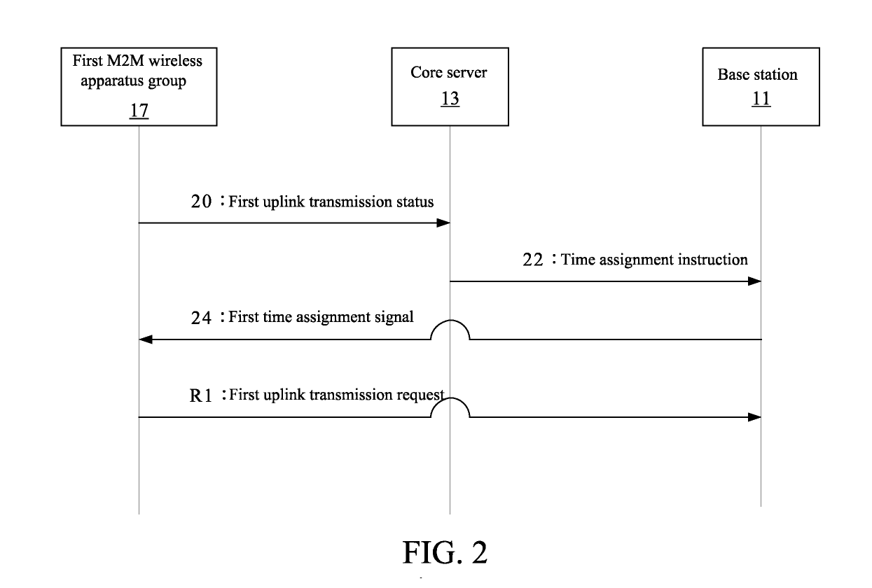

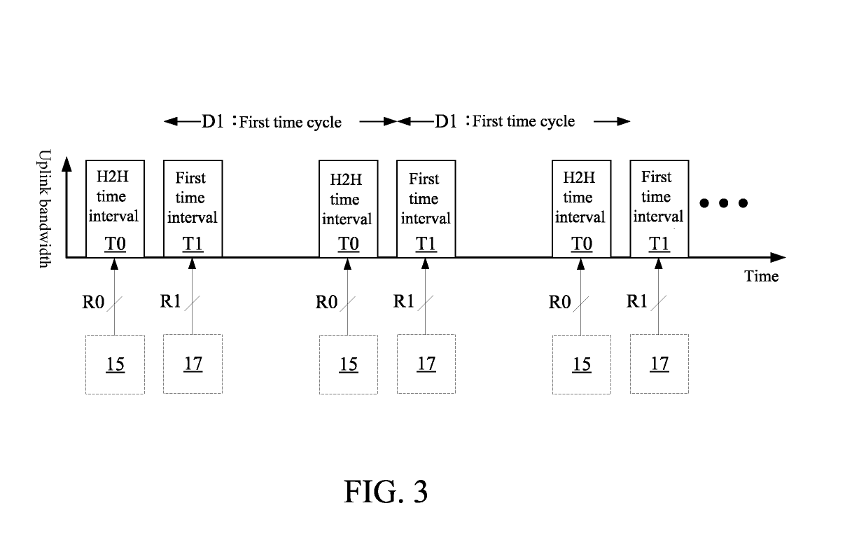

Hereinafter, the method in which the base station 11 assigns the first M2M wireless apparatus group 17 to transmit uplink transmission requests within a first time interval T1 will be further described with reference to FIGS. 2 and 3. The first time interval T1 does not overlap with the H2H time interval T0 in which the H2H wireless apparatus group 15 transmits the plurality of H2H uplink transmission requests R0. FIG. 2 is a flowchart diagram illustrating the operations of the wireless network communication system 1 according to the first embodiment of the present invention; and FIG. 3 is a schematic timing diagram of the wireless network communication system 1 according to the first embodiment of the present invention.

The core server 13 can obtain a first uplink transmission status 20 from the first M2M wireless apparatus group 17 in various ways. Furthermore, the first uplink transmission status 20 of the first M2M wireless apparatus group 17 may comprise but is not limited to the number of first M2M wireless apparatuses 171. In addition the first uplink transmission status 20 is also not limited to the status information, such as the attribute, the characteristic and the uplink transmission time cycle of each of the first M2M wireless apparatuses 171.

After the core server 13 obtains the first uplink transmission status 20 of the first M2M wireless apparatus group 17, the timing generator 133 of the core server 13 creates a time assignment instruction 22 according to the first uplink transmission status 20, with the time assignment instruction 22 comprising a first time cycle D1. Then, the timing generator 133 controls the transceiver 131 to transmit the time assignment instruction 22 to the transceiver 111 of the base station 11. After the time assignment instruction 22 is received by the transceiver 111 of the base station 11, the timing controller 113 of the base station 11 periodically controls the transceiver 111 to transmit a first time assignment signal 24 to the first M2M wireless apparatus group 17 through unicast, multicast or broadcast according to the first time cycle D1 of the time assignment instruction 22.

After the first time assignment signal 24 is received by the first M2M wireless apparatus group 17, the M2M wireless apparatuses of the first M2M wireless apparatus group 17 can get information of uplink transmission requests from the first time assignment signal 24. Then, the M2M wireless apparatuses of the first M2M wireless apparatus group 17 transmit a plurality of first uplink transmission requests R1 to the transceiver 111 of the base station 11 within the first time interval T1. The first time interval T1 is a specific time interval that is determined according to the first uplink transmission status 20 of the first M2M wireless apparatus group 17 and does not overlap with the H2H time interval T0 in which the H2H wireless apparatuses transmit uplink transmission requests.

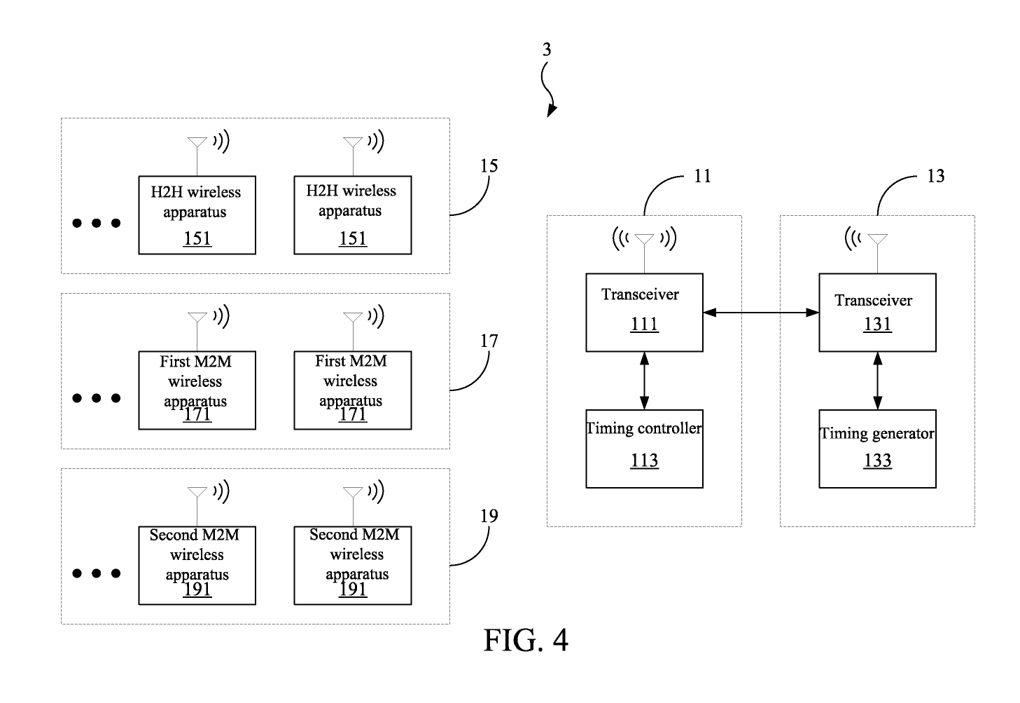

In reference to FIGS. 4, 5 and 6, a second embodiment of the present invention is also a wireless network communication system 3. The wireless network communication system 3 of this embodiment is substantially the same as the wireless network communication system 1 of the first embodiment, so elements other than those to be particularly described in this embodiment may all be viewed as corresponding to those of the wireless network communication system 1 of the first embodiment. Accordingly, the reference numerals and descriptions of some of the elements in the first embodiment still apply to this embodiment, and identical reference numerals shall be considered to represent identical or similar elements, so descriptions thereof will be omitted herein. For the omitted descriptions, reference may be made to the aforesaid embodiment and they will not be further described in this embodiment.

FIG. 4 is a schematic connection diagram of the wireless network communication system 3 according to the second embodiment of the present invention. As shown in FIG. 4, the wireless network communication system 3 comprises a base station 11, a core server 13, an H2H wireless apparatus group 15, a first M2M wireless apparatus group 17 and a second

M2M wireless apparatus group 19. The base station 11, the core server 13, the H2H wireless apparatus group 15 and the first M2M wireless apparatus group 17 may correspond to the elements with the same reference numerals in the wireless network communication system 1 of the first embodiment.

Furthermore, the wireless network communication system 3 of this embodiment conforms to the LTE standard of the 3GPP; however, in other embodiments, the wireless network communication system 3 may also conform to other wireless network communication standards such as the WiMAX standard.

The second M2M wireless apparatus group 19 comprises a plurality of second M2M wireless apparatuses 191, which can communicate with and exchange data with the transceiver 111 of the base station 11 in a wireless way. Those of ordinary skill in the art can readily appreciate that even having only one second M2M wireless apparatus 191 in the second M2M wireless apparatus group 19 will not affect the normal operations of the wireless network communication system 3 of the present invention, and this essentially still falls within the scope of this application. In other words, the number of second M2M wireless apparatus(es) 191 comprised in the second M2M wireless apparatus group 19 is not limited to what is depicted in FIG. 4.

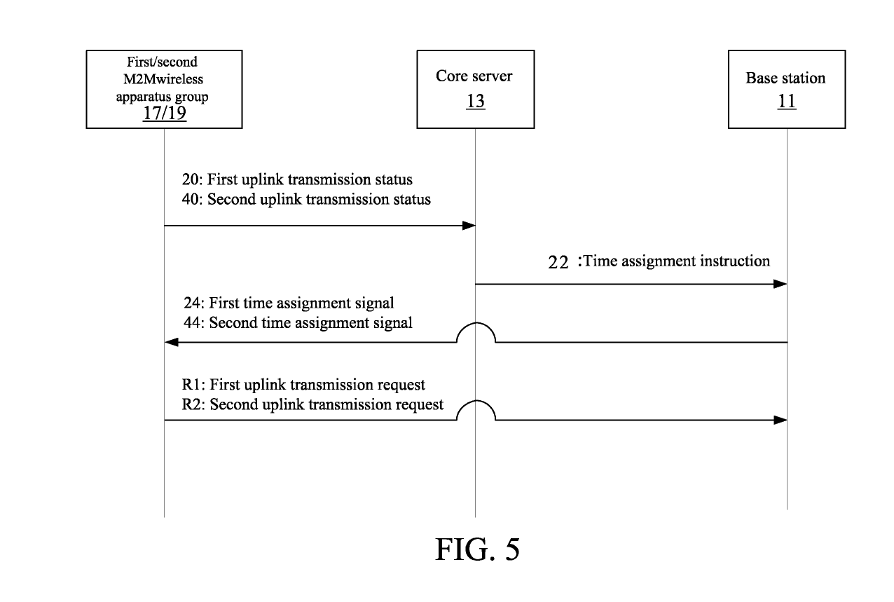

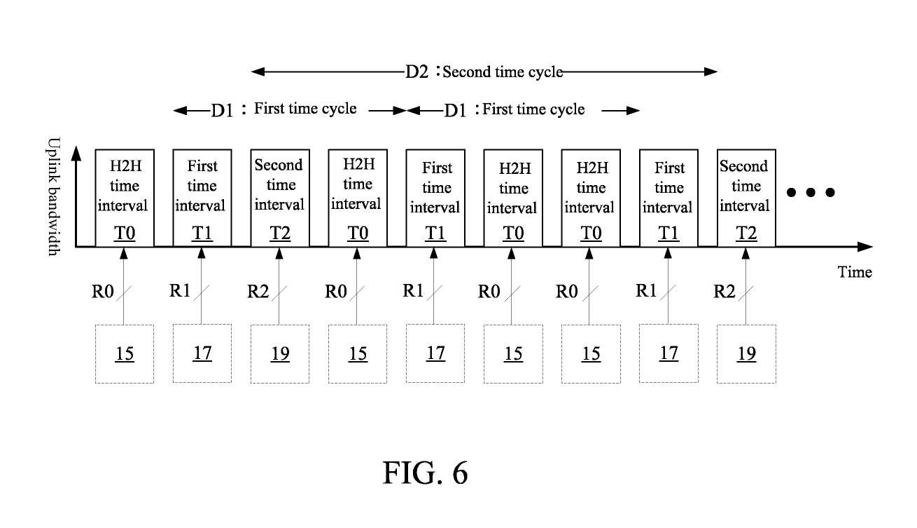

Hereinafter, the method in which the base station 11 assigns the first M2M wireless apparatus group 17 to transmit uplink transmission requests within a first time interval T1 and assigns the second M2M wireless apparatus group 19 to transmit uplink transmission requests within a second time interval T2 will be further described with reference to FIGS. 5 and 6. The first time interval T1, the second time interval T2, and the H2H time interval T0 in which the H2H wireless apparatus group 15 transmits the H2H uplink transmission requests R0 do not overlap with each other. FIG. 5 is a flowchart diagram illustrating the operations of the wireless network communication system 3 according to the second embodiment of the present invention. FIG. 6 is a schematic timing diagram of the wireless network communication system 3 according to the second embodiment of the present invention.

The core server 13 can obtain a first uplink transmission status 20 from the first M2M wireless apparatus group 17 and a second uplink transmission status 40 from the second M2M wireless apparatus group 19 in various ways. After the core server 13 obtains the first uplink transmission status 20 of the first M2M wireless apparatus group 17 and the second uplink transmission status 40 of the second M2M wireless apparatus group 19, the timing generator 133 of the core server 13 creates a time assignment instruction 22 according to the first uplink transmission status 20 and the second uplink transmission status 40, with the time assignment instruction 22 comprising a first time cycle D1 and a second time cycle D2. Then, the timing generator 133 controls the transceiver 131 to transmit the time assignment instruction 22 to the transceiver 111 of the base station 11.

After the time assignment instruction 22 is received by the transceiver 111 of the base station 11, the timing controller 113 of the base station 11 periodically controls the transceiver 111 to transmit a first time assignment signal 24 to the first M2M wireless apparatus group 17 through unicast, multicast or broadcast according to the first time cycle D1 of the time assignment instruction 22, and periodically controls the transceiver 111 to transmit a second time assignment signal 44 to the second M2M wireless apparatus group 19 through unicast, multicast or broadcast according to the second time cycle D2 of the time assignment instruction 22.

After the first time assignment signal 24 is received by the first M2M wireless apparatus group 17, the M2M wireless apparatuses of the first M2M wireless apparatus group 17 can get information of uplink transmission requests from the first time assignment signal 24. Also, after the second time assignment signal 44 is received by the second M2M wireless apparatus group 19, the M2M wireless apparatuses of the second M2M wireless apparatus group 19 can get information of uplink transmission requests from the second time assignment signal 44.

Then, the M2M wireless apparatuses of the first M2M wireless apparatus group 17 transmit a plurality of first uplink transmission requests R1 to the transceiver 111 of the base station 11 within the first time interval T1; and the M2M wireless apparatuses of the second M2M wireless apparatus group 19 transmit a plurality of second uplink transmission requests R2 to the transceiver 111 of the base station 11 within the second time interval T2. It shall be appreciated that the first time interval T1 and the second time interval T2 are two specific time intervals that are determined according to the first uplink transmission status 20 of the first M2M wireless apparatus group 17 and the second uplink transmission status 40 of the second M2M wireless apparatus group 19. Both intervals do not overlap with the H2H time interval T0 in which the H2H wireless apparatuses transmit the uplink transmission requests.

In addition to what is described above, the second embodiment can also execute all the operations and functions set forth in the first embodiment. The method in which the second embodiment executes these operations and functions will be readily appreciated by those of ordinary skill in the art based on the explanation of the first embodiment, and thus will not be further described herein.

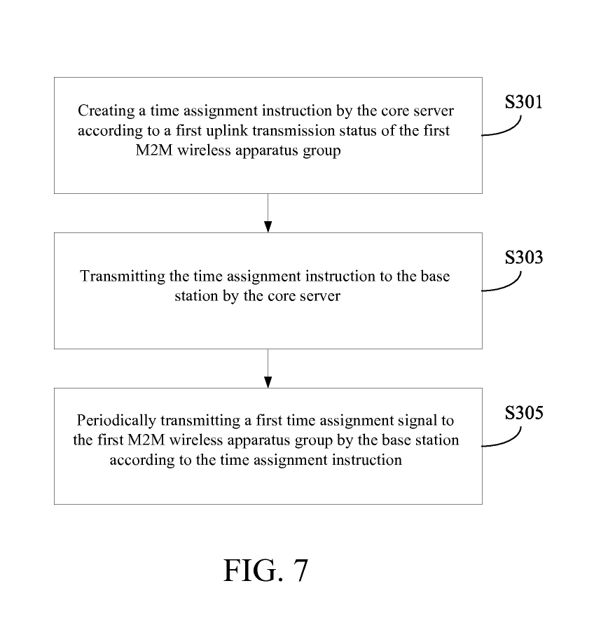

FIG. 7 illustrates a third embodiment of the present invention, which is an uplink transmission method for using in a wireless network communication system. The wireless network communication system comprises a base station, a core server and a first M2M wireless apparatus group. The base station, the core server and the first M2M wireless apparatus group may be viewed as the base station 11, the core server 13 and the first M2M wireless apparatus group 17 described in the first embodiment.

FIG. 7 is a flowchart diagram of an uplink transmission method according to the third embodiment of the present invention. As shown in FIG. 7, step S301 is executed to create a time assignment instruction by the core server according to a first uplink transmission status of the first M2M wireless apparatus group. Step S303 is executed to transmit the time assignment instruction to the base station by the core server. Step S305 is executed to periodically transmit a first time assignment signal to the first M2M wireless apparatus group by the base station according to the time assignment instruction. Thereby, at least one M2M wireless apparatus of the first M2M wireless apparatus group can transmit at least one first uplink transmission request to the base station within a first time interval according to the first time assignment signal.

In addition to the aforesaid steps, the third embodiment can also execute all the operations and functions set forth in the first embodiment. The method in which the third embodiment executes these operations and functions will be readily appreciated by those of ordinary skill in the art based on the explanation of the first embodiment, and thus, will not be further described herein.

On the other hand, the uplink transmission method described in this embodiment may also be implemented by a computer program product. When the computer program product is loaded into the base station and the core server respectively and a plurality of instructions comprised in the computer program product is executed, the uplink transmission method described in this embodiment can be accomplished.

The aforesaid computer program product may be stored in a computer-readable recording medium, such as a read only memory (ROM), a flash memory, a floppy disk, a hard disk, a compact disk (CD), a mobile disk, a magnetic tape, a database accessible to networks, or any other storage media with the same function and well known to those skilled in the art.

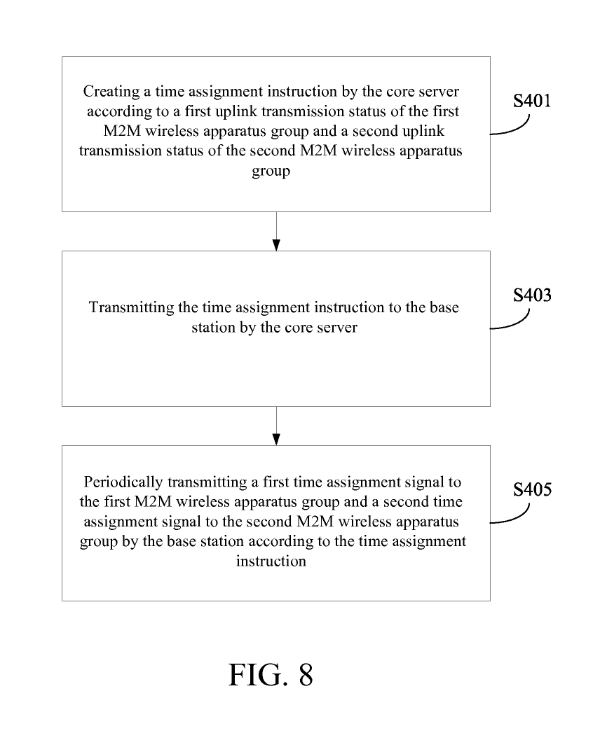

FIG. 8 illustrates the fourth embodiment of the present invention, which is also an uplink transmission method for using in a wireless network communication system. The wireless network communication system comprises a base station, a core server, a first M2M wireless apparatus group and a second M2M wireless apparatus group. The base station, the core server, the first M2M wireless apparatus group and the second M2M wireless apparatus group may be viewed as the base station 11, the core server 13, the first M2M wireless apparatus group 17 and the second M2M wireless apparatus group 19 described in the second embodiment.

FIG. 8 is a flowchart diagram of an uplink transmission method according to the fourth embodiment of the present invention. As shown in FIG. 8, step S401 is executed to create a time assignment instruction by the core server according to a first uplink transmission status of the first M2M wireless apparatus group and a second uplink transmission status of the second M2M wireless apparatus group. Step S403 is executed to transmit the time assignment instruction to the base station by the core server. Step S405 is executed to periodically transmit a first time assignment signal to the first M2M wireless apparatus group and a second time assignment signal to the second M2M wireless apparatus group by the base station according to the time assignment instruction.

Thereby, at least one M2M wireless apparatus of the first M2M wireless apparatus group can transmit at least one first uplink transmission request to the base station within a first time interval according to the first time assignment signal; and at least one M2M wireless apparatus of the second M2M wireless apparatus group can transmit at least one second uplink transmission request to the base station within a second time interval according to the second time assignment signal.

In addition to the aforesaid steps, the fourth embodiment can also execute all the operations and functions set forth in the second embodiment as well as the corresponding operations and functions set forth in the first embodiment. The method in which the fourth embodiment executes these operations and functions will be readily appreciated by those of ordinary skill in the art based on the explanation of the first embodiment and the second embodiment, and thus will not be further described herein. The uplink transmission method described in this embodiment may also be implemented by a computer program product. When the computer program product is loaded into the base station and the core server respectively and a plurality of instructions comprised in the computer program product is executed, the uplink transmission method described in this embodiment can be accomplished.

The aforesaid computer program product may be stored in a computer-readable recording medium, such as a ROM, a flash memory, a floppy disk, a hard disk, a CD, a mobile disk, a magnetic tape, a database accessible to networks, or any other storage media with the same function and well known to those skilled in the art.

According to the above descriptions, by assigning M2M wireless apparatuses belonging to a same group to transmit uplink transmission requests within a specific time interval, the base station, the core server and the uplink transmission method for using in a wireless network communication system according to the present invention can prevent an overlap in the time interval in which the M2M wireless apparatuses transmit uplink transmission requests and the time interval in which H2H wireless apparatuses and M2M wireless apparatuses of other M2M wireless apparatus groups transmit uplink transmission requests without disrupting existing wireless network frameworks. Thereby, the possibilities of preamble collisions among the M2M wireless apparatuses and the H2H wireless apparatuses during uplink data transmissions can be reduced.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station for using in a wireless network communication system, the wireless network communication system comprising a first machine to machine (M2M) wireless apparatus group, a core server and the base station, the core server being configured to create a time assignment instruction according to a first uplink transmission status of the first M2M wireless apparatus group, the base station comprising:
a transceiver, being configured to receive the time assignment instruction from the core server; and
a timing controller, being electronically connected to the transceiver and configured to control the transceiver to transmit a first time assignment signal to the first M2M wireless apparatus group according to the time assignment instruction so that at least one M2M wireless apparatus of the first M2M wireless apparatus group transmits at least one first uplink transmission request to the transceiver in a first time interval according to the first time assignment signal.

2. The base station as claimed in claim 1, wherein the wireless network communication system further comprises a human to human (H2H) wireless apparatus group, the transceiver further receives a plurality of H2H uplink transmission requests of a plurality of H2H wireless apparatuses of the H2H wireless apparatus group in an H2H time interval, and the first time interval does not overlap with the H2H time interval.

3. The base station as claimed in claim 1, wherein the time assignment instruction includes a first time cycle, and the timing controller periodically controls the transceiver to transmit the first time assignment signal to the first M2M wireless apparatus group according to the first time cycle.

4. The base station as claimed in claim 1, wherein the wireless network communication system further comprises a second M2M wireless apparatus group, the core server creates the time assignment instruction according to the first uplink transmission status of the first M2M wireless apparatus group and a second uplink transmission status of the second M2M wireless apparatus group, the timing controller further controls the transceiver to transmit a second time assignment signal to the second M2M wireless apparatus group according to the time assignment instruction so that at least one M2M wireless apparatus of the second M2M wireless apparatus group transmits at least one second uplink transmission request to the transceiver in a second time interval according to the second time assignment signal, and the second time interval does not overlap with the first time interval.

5. The base station as claimed in claim 4, wherein the time assignment instruction includes a first time cycle and a second time cycle, the timing controller periodically controls the transceiver to transmit the first time assignment signal to the first M2M wireless apparatus group according to the first time cycle, the timing controller periodically controls the transceiver to transmit the second time assignment signal to the second M2M wireless apparatus group according to the second time cycle, and the first time cycle and the second time cycle are different.

6. The base station as claimed in claim 1, wherein the wireless network communication system conforms to one of a Long Term Evolution (LTE) standard of a 3rd Generation Partnership Project (3GPP) and a Worldwide Interoperability for Microwave Access (WiMAX) standard.

7. A core server for using in a wireless network communication system, the wireless network communication system comprising a first M2M wireless apparatus group, a base station and the core server, the core server comprising:
a transceiver; and
a timing generator, being electrically connected to the transceiver and configured to execute the following operations:
creating a time assignment instruction according to a first uplink transmission status of the first M2M wireless apparatus group; and
controlling the transceiver to transmit the time assignment instruction to the base station so that the base station transmits a first time assignment signal to the first M2M wireless apparatus group according to the time assignment instruction, and at least one M2M wireless apparatus of the first M2M wireless apparatus group transmits at least one first uplink transmission request to the base station in a first time interval according to the first time assignment signal.

8. The core server as claimed in claim 7, wherein the wireless network communication system further comprises an H2H wireless apparatus group, the base station further receives a plurality of H2H uplink transmission requests of a plurality of H2H wireless apparatuses of the H2H wireless apparatus group in an H2H time interval, and the first time interval does not overlap with the H2H time interval.

9. The core server as claimed in claim 7, wherein the time assignment instruction includes a first time cycle so that the base station periodically transmits the first time assignment signal to the first M2M wireless apparatus group according to the first time cycle.

10. The core server as claimed in claim 7, wherein the wireless network communication system further comprises a second M2M wireless apparatus group, the timing generator creates the time assignment instruction according to the first uplink transmission status of the first M2M wireless apparatus group and a second uplink transmission status of the second M2M wireless apparatus group so that the base station further transmits a second time assignment signal to the second M2M wireless apparatus group according to the time assignment instruction, and at least one M2M wireless apparatus of the second M2M wireless apparatus group transmits at least one second uplink transmission request to the base station in a second time interval according to the second time assignment signal, and the second time interval does not overlap with the first time interval.

11. The core server as claimed in claim 10, wherein the time assignment instruction includes a first time cycle and a second time cycle, the base station periodically transmits the first time assignment signal to the first M2M wireless apparatus group according to the first time cycle, the base station periodically transmits the second time assignment signal to the second M2M wireless apparatus group according to the second time cycle, and the first time cycle and the second time cycle are different.

12. The core server as claimed in claim 7, wherein the wireless network communication system conforms to one of an LTE standard of a 3GPP and a WiMAX standard.

13. An uplink transmission method for using in a wireless network communication system, the wireless network communication system comprising a first M2M wireless apparatus group, a core server and a base station, the uplink transmission method comprising the steps of:
(a) creating a time assignment instruction by the core server according to a first uplink transmission status of the first M2M wireless apparatus group;
(b) transmitting the time assignment instruction to the base station by the core server; and
(c) transmitting a first time assignment signal to the first M2M wireless apparatus group by the base station according to the time assignment instruction so that at least one M2M wireless apparatus of the first M2M wireless apparatus group transmits at least one first uplink transmission request to the base station in a first time interval according to the first time assignment signal.

14. The uplink transmission method as claimed in claim 13, wherein the wireless network communication system further comprises an H2H wireless apparatus group, the base station further receives a plurality of H2H uplink transmission requests of a plurality of H2H wireless apparatuses of the H2H wireless apparatus group in an H2H time interval, and the first time interval does not overlap with the H2H time interval.

15. The uplink transmission method as claimed in claim 13, wherein the time assignment instruction includes a first time cycle, and the base station periodically transmits the first time assignment signal to the first M2M wireless apparatus group according to the first time cycle.

16. The uplink transmission method as claimed in claim 13, wherein the wireless network communication system further comprises a second M2M wireless apparatus group, and the core server creates the time assignment instruction according to the first uplink transmission status of the first M2M wireless apparatus group and a second uplink transmission status of the second M2M wireless apparatus group.

17. The uplink transmission method as claimed in claim 16, wherein the step (c) further comprises the step of:
transmitting a second time assignment signal to the second M2M wireless apparatus group by the base station according to the time assignment instruction so that at least one M2M wireless apparatus of the second M2M wireless apparatus group transmits at least one second uplink transmission request to the base station in a second time interval according to the second time assignment signal, and the second time interval does not overlap with the first time interval.

18. The uplink transmission method as claimed in claim 17, wherein the time assignment instruction includes a first time cycle and a second time cycle, the base station periodically transmits the first time assignment signal to the first M2M wireless apparatus group according to the first time cycle, the base station periodically transmits the second time assignment signal to the second M2M wireless apparatus group according to the second time cycle, and the first time cycle and the second time cycle are different.

19. The uplink transmission method as claimed in claim 13, wherein the wireless network communication system conforms to one of an LTE standard of a 3GPP and a WiMAX standard.
